(19) United States
(12) Patent Application Publication
(10) Pub. No.: US 2024/0001293 A1
(43) Pub. Date: Jan. 4, 2024

(54) PRODUCTION OF COMPRESSED NATURAL GAS FROM RAW BIOGAS USING GAS SEPARATION MEMBRANES INTEGRATED WITH COMPRESSOR TRAIN

(71) Applicant: AIR LIQUIDE ADVANCED TECHNOLOGIES U.S. LLC, Houston, TX (US)

(72) Inventor: Michael MITARITEN, Pittstown, NJ (US)

(73) Assignee: AIR LIQUIDE ADVANCED TECHNOLOGIES U.S. LLC, Houston, TX (US)

(21) Appl. No.: 17/853,770

(22) Filed: Jun. 29, 2022

(51) Int. Cl. B01D 53/22; C10L 3/10

(52) U.S. Cl. CPC B01D 53/226; B01D 53/229; C10L 3/104; C10L 2290/548

(57) ABSTRACT

A stream of raw biogas is feed to an upstream-most compression stage of a multi-stage compression unit to produce a feed gas for separation by a gas separation membrane-based purification unit into a methane-enriched product gas stream, one or more recycle gas streams, and one or more waste gas streams. The methane-enriched product gas stream is compressed by a downstream or downstream-most compression stage of the multi-stage compression unit to produce a stream of product compressed natural gas.

### CROSS-REFERENCE TO RELATED APPLICATIONS

None.

### BACKGROUND

### Field of the Invention

The present invention relates to production of compressed natural gas from raw biogas using gas separation membrane modules that are integrated with a compressor train.

### Related Art

Biogas typically refers to a mixture of different gases produced from the breakdown of organic matter without oxygen in an anaerobic digestion process.

Biogas can be produced from raw materials such as agricultural waste, manure, municipal waste, plant material, sewage, green waste or food waste. Biogas typically comprises as the main components 50-70% of methane and 20 to 50% carbon dioxide with lower levels of other components such as N₂ and O₂, up to 5,000 ppm or more of hydrogen sulfide, siloxanes, up to 1,000-2,000 ppm of volatile organic compounds (VOCs), and is saturated with water. Biogas also includes landfill gas, which is derived from solid waste landfills that decompose to the organic waste with time, via microbe digestion of the variety of organic waste to produce methane and carbon dioxide. In either case, biogas includes high concentrations of methane and carbon dioxide, water vapor, and lesser concentrations of VOC's and other contaminants.

Specifically, digester biogas (“digester gas”) or landfill gas is a type of renewable energy. Compressed natural gas is a combustible fuel for supplying energy, and also as a raw material in many industrial significant processes. Thus, it is very desirable from an economic and environmental viewpoint to capture the methane from digester or landfill exhaust gas to produce compressed natural gas, especially since biogas is a renewable source and not a fossil fuel.

If digester and landfill exhaust gas is not recovered, the methane that escapes into ambient air becomes a source of air pollution. Accordingly, it is further desirable to prevent the methane emissions produced from the anaerobic digestion, for environmental protection purposes. Traditionally, digester or landfill exhaust gas has been burnt in an open flame incinerator such as a flare stack, to prevent the gas from escaping to the environment. This burning process is inefficient, and consequently, a large fraction of the methane and other obnoxious contaminants in the exhaust gas survive to pollute the ambient air. Further when combusted CO₂, a potent greenhouse gas, is emitted. Also, common flare stack operations are a waste of the useful energy held by the methane in the exhaust gas.

Membranes have been used for biogas treatment. Typical membrane processes involve first removal of H₂S by a sulfur removal unit, a further pretreatment by refrigeration and adsorption processes to remove water and VOCs, then followed by a two-stage membrane process that is dedicated to CO₂ removal, and further recycling/processing of the permeate from the second separation stage of membrane. U.S. Pat. No. 7,025,803 discloses a two-stage membrane process, U.S. Pat. No. 8,999,038 discloses a three-stage membrane process, and U.S. Pat. No. 9,988,326 discloses a four-stage membrane process.

In many cases, the methane-enriched product gas from such membrane processes is delivered to a pipeline. It is also common to use the gas produced directly for fuel as compressed natural gas (CNG) or for transport to end users via compression and injection into a pipeline (such as those connected to a natural gas grid). Whether the gas produced is used directly for fuel as CNG or the CNG is injected into a pipeline, the delivery pressure is typically about 3600 psig.

A typical route to such purification and delivery is shown in FIG. 1. A stream of biogas 1 is combined with a stream of permeate gas 3 and the combined stream 5 is fed to a first compression unit 7 including first, second, third, and fourth compression stages 8, 10, 12, 14. The feed gas 9, now at the desired pressure, is fed to a first gas separation membrane stage 11 where it is separated into a first methane-enriched and carbon dioxide-deficient stream of residue gas 13 and a first methane-deficient and carbon dioxide-enriched stream of permeate gas 15. The residue gas stream 13 is fed to a second gas separation stage 17 where it is separated into a second methane-enriched and carbon dioxide-deficient stream of residue gas 19 and a second methane-deficient and carbon dioxide-enriched stream of permeate gas 3. Residue gas stream 19 is fed to a second compression unit 23 containing first, second, third, and fourth compression stages 24, 26, 28, 30 where it is compressed up to the desired pressure to product compressed natural gas stream 25 useful as a fuel for CNG engines or for injection into a natural gas pipeline.

This conventional scheme requires two separate compression units each typically containing three or more (in the illustrated example of FIG. 1, four) compressors arranged in a compression train in which the gas compressed by the first stage of the train is further compressed by the second stage, the gas compressed by the second stage is further compressed by the third stage, and so on, until the final compressor in the train compresses the gas to the final desired pressure. The use of two separate compression units is costly, especially for systems with a relatively smaller size.

Thus, there is a need for an improved method and system for production of compressed natural gas from raw biogas that does not require two separate compression units as is required by conventional schemes.

### SUMMARY

There is disclosed a method of producing compressed natural gas from raw biogas. The method includes the following steps. A stream of raw biogas is provided that includes 50-70 vol % methane, 20-50 vol % carbon dioxide, and lower levels of other contaminants including nitrogen, oxygen, hydrogen sulfide, optionally siloxanes, and optionally VOCs. The raw biogas stream is fed to an upstream-most compression stage of a multi-stage compression unit comprising two or more compression stages. The raw biogas stream is compressed in one or more compression stages of said multi-stage compression unit along with one or more recycle gas streams to produce a stream of feed gas having a pressure higher than that of the raw biogas stream. The feed gas stream is optionally subjected to pretreatment for removal of one or more of said contaminants with pretreatment equipment. The feed gas stream, after optionally pretreating with said optional pretreatment equipment, is fed to a gas separation membrane-based purification system comprising two or more gas separation membrane-based purification stages, each comprising one or more banks of one or more gas separation membrane modules arranged in parallel or in series, to produce a methane-enriched product gas stream, one or more waste gas streams, and one or more recycle gas streams. The methane-enriched product gas stream is compressed in one or more of the compression stages including a downstream-most compression stage of said multi-stage compression unit to produce a stream of compressed natural gas having a pressure of 30-250 bar. The stream of compressed natural gas is withdrawn as product compressed natural gas. The one or more recycle gas streams are fed to the upstream-most compression stage for compression together with the raw biogas stream or combining said one or more recycle gas streams with said raw biogas stream prior to their being fed to the upstream-most compression stage.

The above-disclosed method and/or system may include one or more of the following aspects:
the feed gas stream is subjected to pretreatment for removal of one or more of said contaminants with said pretreatment equipment, including one or more of a coalescer, a PSA unit, and a non-regenerable guard bed.
wherein the multi-stage compression unit includes, in series, first, second, and third compression stages, and: the raw biogas stream and said one or more recycle gas streams are compressed by the first compression stage and the methane-enriched product gas stream is fed to the second compression stage, or the raw biogas stream and said one or more recycle gas streams are compressed by the first and second compression stages and the methane-enriched product gas stream is fed to the third compression stage.
the multi-stage compression unit includes, in series, first, second, third, and fourth compression stages, and: the raw biogas stream and said one or more recycle gas streams are compressed by the first and second compression stages and the methane-enriched product gas stream is fed to the third compression stage, or the raw biogas stream and said one or more recycle gas streams are compressed by the first, second, and third compression stages and the methane-enriched product gas stream is fed to the fourth compression stage.
the multi-stage compression unit includes, in series, first, second, third, fourth, and fifth compression stages, and: the raw biogas stream and said one or more recycle gas streams are compressed by the first and second compression stages and the methane-enriched product gas stream is fed to the third compression stage, or the raw biogas stream and said one or more recycle gas streams are compressed by the first, second, and third compression stages and the methane-enriched product gas stream is fed to the fourth compression stage, or the raw biogas stream and said one or more recycle gas streams are compressed by the first, second, third, and fourth compression stages and the methane-enriched product gas stream is fed to the fifth compression stage.
the multi-stage compression unit includes, in series, first, second, third, fourth, fifth, and sixth compression stages, and the raw biogas stream and said one or more recycle gas streams are compressed by the first and second compression stages and the methane-enriched product gas stream is fed to the third compression stage, or the raw biogas stream and said one or more recycle gas streams are compressed by the first, second, and third compression stages and the methane-enriched product gas stream is fed to the fourth compression stage, or the raw biogas stream and said one or more recycle gas streams are compressed by the first, second, third, and fourth compression stages and the methane-enriched product gas stream is fed to the fifth compression stage, or the raw biogas stream and said one or more recycle gas streams are compressed by the first, second, third, fourth, and fifth compression stages and the methane-enriched product gas stream is fed to the sixth compression stage.
said gas separation membrane-based purification system comprises first and second gas separation membrane-based purification stages and said method further comprises the steps of: separating the feed gas with said first gas separation membrane-based purification stage into a first methane-enriched and carbon dioxide-deficient residue gas stream and a first methane-deficient and carbon dioxide-enriched permeate gas stream; and separating all or some of the first methane-enriched and carbon dioxide-deficient residue gas stream with said second gas separation membrane-based purification stage into a second methane-enriched and carbon dioxide-deficient residue gas stream and a second methane-deficient and carbon dioxide-enriched permeate gas stream, the second methane-enriched and carbon dioxide-deficient residue gas stream being the methane-enriched product gas stream, said one or more recycle gas streams comprising the second methane-deficient and carbon dioxide-enriched permeate gas stream.
said gas separation membrane-based purification system comprises first, second, and third gas separation membrane-based purification stages and said method further comprises the steps of: separating the feed gas with said first gas separation membrane-based purification stage into a first methane-enriched and carbon dioxide-deficient residue gas stream and a first methane-deficient and carbon dioxide-enriched permeate gas stream; separating all or some of the first methane-enriched and carbon dioxide-deficient residue gas stream with said second gas separation membrane-based purification stage into a second methane-enriched and carbon dioxide-deficient residue gas stream and a second methane-deficient and carbon dioxide-enriched permeate gas stream, the second methane-enriched and carbon dioxide-deficient residue gas stream being the methane-enriched product gas stream; and separating some or all of the first methane-deficient and carbon dioxide-enriched permeate with said third gas separation membrane-based purification stage into a third methane-enriched and carbon dioxide-deficient residue gas stream and a third methane-deficient and carbon dioxide-enriched permeate gas stream, said one or more recycle gas streams being the second methane-deficient and carbon dioxide-enriched permeate gas stream and the third methane-enriched and carbon dioxide-deficient residue stream.
said gas separation membrane-based purification system comprises first, second, third, and fourth gas separation membrane-based purification stages and said method further comprises the steps of: separating the feed gas with said first gas separation membrane-based purification stage into a first methane-enriched and carbon dioxide-deficient residue gas stream and a first methane-deficient and carbon dioxide-enriched permeate gas stream; separating all or some of the first methane-enriched and carbon dioxide-deficient residue gas stream with said second gas separation membrane-based purification stage into a second methane-enriched and carbon dioxide-deficient residue gas stream and a second methane-deficient and carbon dioxide-enriched permeate gas stream, the second methane-enriched and carbon dioxide-deficient residue gas stream being the methane-enriched product gas stream; separating some or all of the first methane-deficient and carbon dioxide-enriched permeate with said third gas separation membrane-based purification stage into a third methane-enriched and carbon dioxide-deficient residue gas stream and a third methane-deficient and carbon dioxide-enriched permeate gas stream; and separating some or all of the third methane-enriched and carbon dioxide-deficient residue with said fourth gas separation membrane-based purification stage into a fourth methane-enriched and carbon dioxide-deficient residue gas stream and a fourth methane-deficient and carbon dioxide-enriched permeate gas stream, said one or more recycle gas streams being the second methane-deficient and carbon dioxide-enriched permeate gas stream and the fourth methane-enriched and carbon dioxide-deficient residue stream.
said stream of raw biogas is obtained from a landfill.
said stream of raw biogas is obtained from a digester.
the multi-stage compression unit comprises two to seven compression stages.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a schematic of a prior art two gas separation membrane stage-based purification scheme for the production of compressed natural gas.

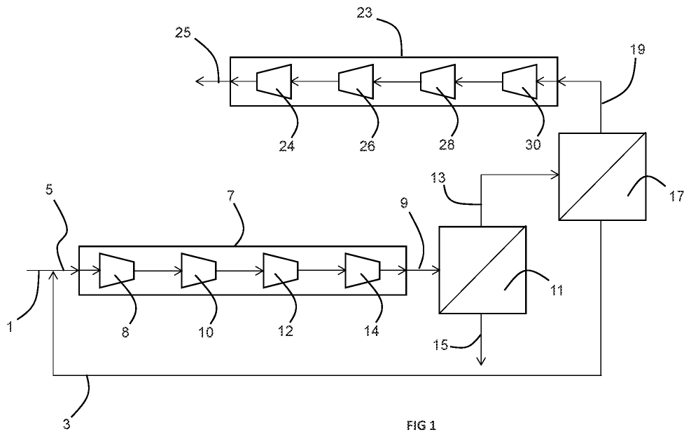

FIG. 2 is a schematic of an embodiment of the invention including a CNG production scheme including two gas separation membrane stages integrated between different stages of a compression unit.

FIG. 3 is a schematic of an embodiment of the invention including a CNG production scheme including three gas separation membrane stages integrated between different stages of a compression unit.

FIG. 4 is a schematic of an embodiment of the invention including a CNG production scheme including four gas separation membrane stages integrated between different stages of a compression unit.

### DESCRIPTION OF PREFERRED EMBODIMENTS

We have invented a method and system for the production of compressed natural gas that uses only a single compression unit. One or more upstream compression stages in a single multi-stage compression unit compress a stream raw biogas, along with one or more recycle gases, up to a desired pressure, thereby producing a stream of feed gas for feeding to a gas separation membrane-based purification system that includes two or more gas separation membrane-based purification stages. The gas separation membrane-based purification system separates the compressed feed gas into a methane-enriched product gas stream, one or more waste gas streams, and one or more recycle gas streams. The methane-enriched product gas ordinarily meets the compositional specifications for compressed natural gas. However, it does not have the requisite pressure, so it is fed to a downstream or downstream-most compressions stage of the multi-stage compression unit to produce product compressed natural gas.

In this manner, one or more upstream compression stages are used to raise the pressure of the raw biogas and one or more recycle gases up to a predetermined pressure or pressure range suitable for separation by the gas separation membrane-based purification system while one or more downstream compression stages are used to raise the pressure of the methane-enriched product gas up to a predetermined pressure or pressure range that meets a specification for compressed natural gas. While not limiting, this typically includes pressure 3626 psi (250 bar), more typically around 435-3626 psi (30-250 bar), and even more typically either of two particular pressure standards employed in the US and elsewhere, including around 3000 psi (207 bar) and around 3600 psi (248 bar). By around, I mean+/−10%.

The raw biogas is obtained from a landfill or digester and typically has a composition including 50-70% of methane and 20 to 50% carbon dioxide, with lower levels of other components such as N₂ and O₂, up to 5,000 ppm or more of hydrogen sulfide, optionally siloxanes, optionally up to 1,000-2,000 ppm of volatile organic compounds (VOCs), and is saturated with water.

Each of the gas separation membrane-based purification stages (hereinafter “membrane stages”) includes one or more banks of membrane modules arranged in series or in parallel.

Each of the membranes of the membrane modules is selective for carbon dioxide over methane. This means that the carbon dioxide in the gas fed that is fed to the membrane will enrich on a lower pressure permeate side of the membranes while the methane in the fed gas will enrich on a higher pressure residue side of the membrane. The membranes of membrane modules within a given bank may be the same as or different from one another, but typically are the same. The membranes of within a given separation unit may be the same as or different from one another, but typically are the same. The membranes of one membrane stage may be the same as or different from those of one or more of the other stages, but typically are the same.

I will now proceed with a description of four embodiments of the invention.

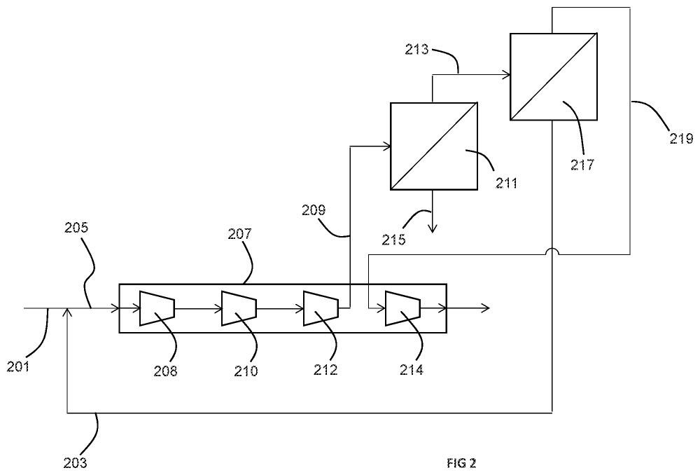

In a two membrane stage embodiment illustrated in FIG. 2, a feed stream 201 combined with a recycle stream 203 (the permeate gas stream from the second stage) and the combined stream 205 is fed to a first compression unit 207.

Unit 207 is a multi-stage-type compression unit that includes a plurality of compressor stages arranged in series. While not limited as such, for centrifugal compression-type compression units, typically there are 4 or 5 or 6 or 7 compressor stages arranged in series. While also not limited as such, for reciprocating-type compression units or screw-driven compression units, there may be 3-6 compressor stages arranged in series. For the sake of illustration, unit 207 in the embodiment of FIG. 2 includes first, second, third, and fourth compression stages 208, 210, 212, 214. One of ordinary skill in the art will recognize that unit 207 may include fewer or more compression stages in practice of the invention. Each stage often will include a chiller and condenser for cooling and removing condensed gases from the pressurized gas produced by that stage.

According to the invention, we have modified the use of an otherwise-conventional compression train so that it can be used to separately compress two different gases. Those skilled in the art will recognize that compression trains are typically used to compress a gas in each of the sequential compressors from low to medium to high pressure. For example, in a conventional 4-compression stage compression unit, gas is sequentially compressed by the upstream-most compressor to a low pressure, compressed by the next upstream-most compressor to a moderately low pressure, compressed by the next upstream-most compressor to a moderate high pressure, and compressed by the downstream-most compressor to a high pressure.

Regardless of how many compression stages the multi-stage compressor has, those skilled in the art will recognize that it includes an upstream-most compression stage and a downstream-most compression stage. Depending upon how many compression stages it has, it may also have an upstream compression stage which is downstream of the upstream-most compression stage and/or a downstream compression stage which is upstream of the downstream-most compression stage.

In an example, for a 3-compression stage multi-stage compression unit, there are, in order, an upstream-most compression stage, another compression stage which may be termed an upstream compression stage or a downstream compression stage, and a downstream-most compressions stage.

In another example, for a 4-compression stage multi-stage compression unit, there are, in order, an upstream-most compression stage, an upstream compression stage, a downstream compression stage, and a downstream-most compressions stage. Skilled artisans will understand that the foregoing nomenclature may also be applied to 5-stage or 6-stage multi-stage compression units.

In yet another example, for a 5-compression stage multi-stage compression unit, there are, in order, an upstream-most compression stage, an upstream compression stage, middle compression stage which may be called a upstream or a downstream compression stage, a downstream compression stage, and a downstream-most compressions stage.

In still another example, for a 6-compression stage multi-stage compression unit, there are, in order, an upstream-most compression stage, an upstream compression stage, another upstream compression stage, a downstream compression stage, another downstream compression stage, and a downstream-most compressions stage.

In yet another example, for a 7-compression stage multi-stage compression unit, there are, in order, an upstream-most compression stage, an upstream compression stage, another upstream compression stage, a middle compression stage which may be called an upstream or a downstream compression stage, a downstream compression stage, another downstream compression stage, and a downstream-most compressions stage.

Allow us to provide a contrasting example in practice of the invention while applying the invention to the above-described 4-compressor compression unit example. Combined gas stream 205 would be sequentially compressed to a low pressure by the first compression stage 208 (i.e., the upstream-most). This low pressure gas is then fed to the second compression stage 210 (i.e., upstream) where it is compressed to moderately low pressure and the moderately low pressure gas produced by the second compression stage 210 is fed to the third compression stage 212 (i.e., downstream compression stage) where it is compressed it to a moderately high pressure. Instead of feeding the moderately high pressure gas produced by the third compression stage 212 to the fourth compression stage 214 (i.e., the downstream-most compression stage) for compression to a high pressure gas, the moderately high pressure gas is instead fed to two or more gas separation module-based purification process (described below) before the methane-enriched gas resulting from that membrane purification process is returned to the compression unit 207 where it is fed to the fourth compression stage 214 where it is compressed to high pressure.

Instead of withdrawing the moderately high pressure gas from the third compression stage 212 and returning the methane-enriched gas to the fourth compression stage 214, the moderately low pressure gas may instead be withdrawn from the second compression stage 210 and the methane-enriched gas is returned to the third compression stage 212 where it is compressed to a moderately high pressure and subsequently compressed to high pressure by the fourth compression stage 214.

Skilled artisans will understand that the invention is not limited to the aforementioned withdrawal and return compressions stages. For example, the low pressure gas may be withdrawn from the first compression stage 208 and returned to the second compression stage 210 where it is compressed by the second, third, and fourth compression stages 210, 212, 214. Skilled artisans will also recognize that this principle may be extended to points in between various compressions stages in three, five, six, or seven-compression stage compression units.

Returning to the gas separation membrane module portion of the purification scheme, the moderately high pressure gas 209 may optionally be pretreated with pretreatment equipment prior to being fed to first membrane stage 211. Alternatively, the gas fed to the first membrane stage 211 (whether pretreated or not) is not comprised only of the moderately high pressure gas from the third compression stage 212. Rather, such a gas may be comprised of a portion of the moderately low pressure gas from the second compression stage 210 and a portion of the moderately high pressure gas from the third compression stage 212. Also, such a gas may be comprised of a portion of the low pressure gas from the first compression stage 208 and a portion of either the moderately low pressure gas from the second compression stage 210 or the moderately high pressure gas from the third compression stage 212.

Pretreatment equipment includes a coalescer where droplets of oil or other liquids entrained with the moderately high pressure gas 209 are removed on one or more screens, a PSA unit to remove hydrogen sulfide and VOCs, and/or a non-regenerable guard bed containing an adsorbent such as activated carbon to “polish” the gas and remove various contaminants to relatively low levels.

Regardless of whether the moderately high pressure gas 209 is first pretreated (as described above) or not, it is fed to a first membrane stage 211 where it is separated into a first methane-enriched and carbon dioxide-deficient residue gas stream 213 and a first methane-deficient and carbon dioxide-enriched permeate gas stream 215. Stream 215 may be vented, used to regenerate the optional PSA unit and thereafter destroyed in a thermal oxidation unit, or recovered or used in any other manner.

All or some of the first residue gas stream 213 is fed to a second membrane stage 217 where it is separated into a second methane-enriched and carbon dioxide-deficient residue gas stream 219 and a second methane-deficient and carbon dioxide-enriched permeate gas stream 221. All or some of the residue stream 219 is then fed to the fourth compression stage 214 of unit 207 where it is compressed to the final, high pressure as product compressed natural gas stream 225.

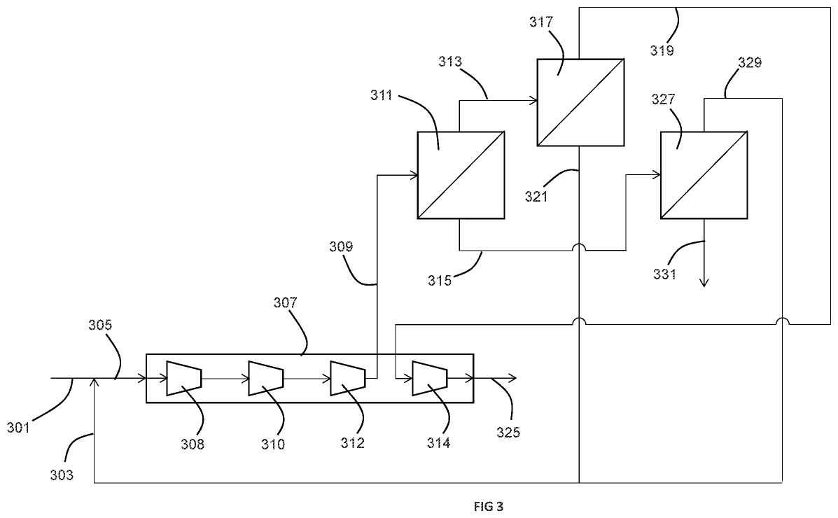

In a three membrane stage embodiment illustrated in FIG. 3, a feed stream 301 combined with a recycle stream 303 (the permeate gas stream from the second stage) and the combined stream 305 is fed to a first compression unit 307.

Unit 307 may be one of the same types as those described above for the embodiment of FIG. 2. For the sake of illustration, unit 307 in the embodiment of FIG. 3 includes first, second, third, and fourth compression stages 308, 310, 312, 314. One of ordinary skill in the art will recognize that unit 307 may include fewer or more compression stages in practice of the invention. Each stage often will include a chiller and condenser for cooling and removing condensed gases from the pressurized gas produced by that stage.

According to the invention and in the same manner as described for the embodiment of FIG. 2, we have modified the use of an otherwise-conventional compression train so that it can be used to separately compress two different gases. Thus, combined gas stream 305 would be sequentially compressed to a low pressure by the first compression stage 308. This low pressure gas is then fed to the second compression stage 310 where it is compressed to moderately low pressure and the moderately low pressure gas produced by the second compression stage 310 is fed to the third compression stage 312 where it is compressed it to a moderately high pressure. Instead of feeding the moderately high pressure gas produced by the third compression stage 312 to the fourth compression stage 314 for compression to a high pressure gas, the moderately high pressure gas is instead fed to two or more gas separation module-based purification process (described below) before the methane-enriched gas resulting from that membrane purification process is returned to the compression unit 307 where it is fed to the fourth compression stage 314 where it is compressed to high pressure.

Instead of withdrawing the moderately high pressure gas from the third compression stage 312 and returning the methane-enriched gas to the fourth compression stage 314, the moderately low pressure gas may instead be withdrawn from the second compression stage 310 and the methane-enriched gas is returned to the third compression stage 312 where it is compressed to a moderately high pressure and subsequently compressed to high pressure by the fourth compression stage 314.

Skilled artisans will understand that the invention is not limited to the aforementioned withdrawal and return compressions stages. For example, the low pressure gas may be withdrawn from the first compression stage 308 and returned to the second compression stage 310 where it is compressed by the second, third, and fourth compression stages 310, 312, 314. Skilled artisans will also recognize that this principle may be extended to points in between various compressions stages in three, five, six, or seven-compression stage compression units.

As with the moderately high pressure gas 209 of the embodiment of FIG. 2, the moderately high pressure gas 309 may optionally be pretreated with pretreatment equipment prior to being fed to first membrane stage 311. Alternatively, the gas fed to the first membrane stage 311 (whether pretreated or not) is not comprised only of the moderately high pressure gas from the third compression stage 312. Rather, such a gas may be comprised of a portion of the moderately low pressure gas from the second compression stage 310 and a portion of the moderately high pressure gas from the third compression stage 312. Also, such a gas may be comprised of a portion of the low pressure gas from the first compression stage 308 and a portion of either the moderately low pressure gas from the second compression stage 310 or the moderately high pressure gas from the third compression stage 312.

Pretreatment equipment includes a coalescer where droplets of oil or other liquids entrained with the moderately high pressure gas 209 are removed on one or more screens, a PSA unit to remove hydrogen sulfide and VOCs, and/or a non-regenerable guard bed containing an adsorbent such as activated carbon to “polish” the gas and remove various contaminants to relatively low levels. Regardless of whether the moderately high pressure gas 309 is first pretreated (as described above) or not, it is fed to a first membrane stage 311 where it is separated into a first methane-enriched and carbon dioxide-deficient residue gas stream 313 and a first methane-deficient and carbon dioxide-enriched permeate gas stream 315.

All or some of the first residue gas stream 313 is fed to a second membrane stage 317 where it is separated into a second methane-enriched and carbon dioxide-deficient residue gas stream 319 and a second methane-deficient 319 carbon dioxide-enriched permeate gas stream 321. All or some of the residue stream 319 is then fed to the fourth compression stage 314 of unit 307 where it is compressed to the final, high pressure as product compressed natural gas stream 325.

All or some of the first permeate gas stream 315 is fed to a third membrane stage 327 where it is separated into a third methane-enriched and carbon dioxide-deficient residue gas stream 329 and a third methane-deficient 331 carbon dioxide-enriched permeate gas stream 321.

Stream 331 may be vented, used to regenerate the optional PSA unit and thereafter destroyed in a thermal oxidation unit, or recovered or used in any other manner.

All or some of either of or both of the second permeate gas stream 321 and the third retentate gas stream 329 may optionally be recycled to the suction inlet of compression unit 307. While FIG. 3 illustrates combination of streams 321, 329 and subsequent combination with raw biogas stream 301, they need not be combined in such a manner. Either or both of streams 321, 329 may be separately fed to the suction inlet of compression unit 307 or combined with stream 301 prior to being compressed in compression unit 307.

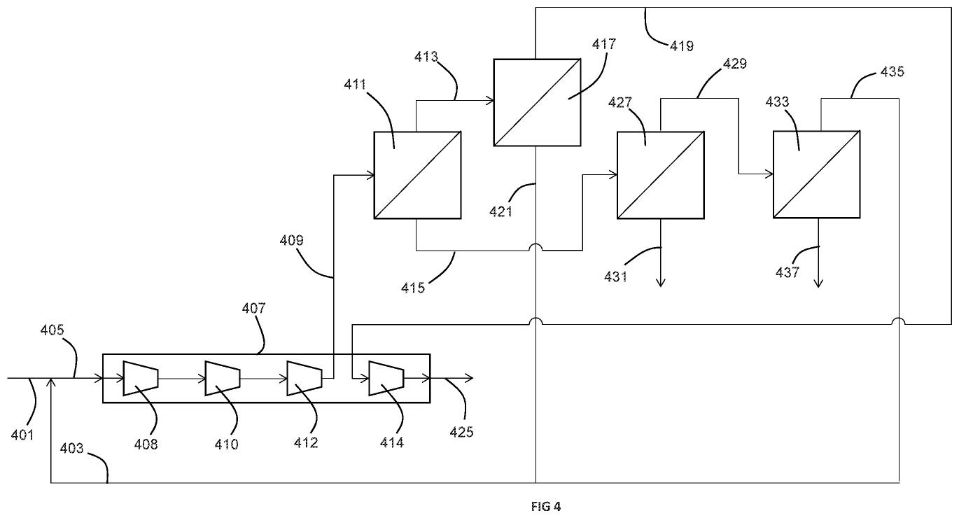

In a four membrane stage embodiment illustrated in FIG. 4, a feed stream 401 combined with a recycle stream 403 (the permeate gas stream from the second stage) and the combined stream 405 is fed to a first compression unit 407.

Unit 407 may be one of the same types as those described above for the embodiment of FIG. 2. For the sake of illustration, unit 407 in the embodiment of FIG. 4 includes first, second, third, and fourth compression stages 408, 410, 412, 414. One of ordinary skill in the art will recognize that unit 407 may include fewer or more compression stages in practice of the invention. Each stage often will include a chiller and condenser for cooling and removing condensed gases from the pressurized gas produced by that stage.

According to the invention and in the same manner as described for the embodiment of FIG. 2, we have modified the use of an otherwise-conventional compression train so that it can be used to separately compress two different gases. Thus, combined gas stream 405 would be sequentially compressed to a low pressure by the first compression stage 408. This low pressure gas is then fed to the second compression stage 410 where it is compressed to moderately low pressure and the moderately low pressure gas produced by the second compression stage 410 is fed to the third compression stage 412 where it is compressed it to a moderately high pressure. Instead of feeding the moderately high pressure gas produced by the third compression stage 412 to the fourth compression stage 414 for compression to a high pressure gas, the moderately high pressure gas is instead fed to two or more gas separation module-based purification process (described below) before the methane-enriched gas resulting from that membrane purification process is returned to the compression unit 407 where it is fed to the fourth compression stage 414 where it is compressed to high pressure.

Instead of withdrawing the moderately high pressure gas from the third compression stage 412 and returning the methane-enriched gas to the fourth compression stage 414, the moderately low pressure gas may instead be withdrawn from the second compression stage 410 and the methane-enriched gas is returned to the third compression stage 412 where it is compressed to a moderately high pressure and subsequently compressed to high pressure by the fourth compression stage 414.

Skilled artisans will understand that the invention is not limited to the aforementioned withdrawal and return compressions stages. For example, the low pressure gas may be withdrawn from the first compression stage 408 and returned to the second compression stage 410 where it is compressed by the second, third, and fourth compression stages 410, 412, 414. Skilled artisans will also recognize that this principle may be extended to points in between various compressions stages in three, five, six, or seven-compression stage compression units.

As with the moderately high pressure gas 209 of the embodiment of FIG. 2, the moderately high pressure gas 409 may optionally be pretreated with pretreatment equipment prior to being fed to first membrane stage 411. Alternatively, the gas fed to the first membrane stage 411 (whether pretreated or not) is not comprised only of the moderately high pressure gas from the third compression stage 412. Rather, such a gas may be comprised of a portion of the moderately low pressure gas from the second compression stage 410 and a portion of the moderately high pressure gas from the third compression stage 412. Also, such a gas may be comprised of a portion of the low pressure gas from the first compression stage 408 and a portion of either the moderately low pressure gas from the second compression stage 410 or the moderately high pressure gas from the third compression stage 412.

Regardless of whether the moderately high pressure gas 409 is first pretreated (as described above) or not, it is fed to a first membrane stage 411 where it is separated into a first methane-enriched and carbon dioxide-deficient residue gas stream 413 and a first methane-deficient and carbon dioxide-enriched permeate gas stream 415.

All or some of the first residue gas stream 413 is fed to a second membrane stage 417 where it is separated into a second methane-enriched and carbon dioxide-deficient residue gas stream 419 and a second methane-deficient 419 carbon dioxide-enriched permeate gas stream 421. The residue stream 419 is then fed to the fourth compression stage 414 of unit 407 where it is compressed to the final, high pressure as product compressed natural gas stream 425.

All or some of the first permeate gas stream 415 is fed to a third membrane stage 427 where it is separated into a third methane-enriched and carbon dioxide-deficient residue gas stream 429 and a third methane-deficient carbon dioxide-enriched permeate gas stream 421.

All or some of stream 429 is fed to a fourth membrane stage 433 where it is separated into a fourth methane-enriched and carbon dioxide-deficient residue gas stream 435 and a fourth methane-deficient carbon dioxide-enriched permeate gas stream 437.

Streams 431, 437 may be vented, used to regenerate the optional PSA unit and thereafter destroyed in a thermal oxidation unit, or recovered or used in any other manner.

All or or some of either or both of the second permeate gas stream 421 and the fourth retentate gas stream 435 may optionally be recycled to the suction inlet of compression unit 407. While FIG. 4 illustrates combination of streams 421, 435 and subsequent combination with raw biogas stream 401, they need not be combined in such a manner. Either or both of streams 421, 435 may be separately fed to the suction inlet of compression unit 407 or combined with stream 401 prior to being compressed in compression unit 407.

The advantage of the invention is use of only a single multi-stage compression unit, leading to lower capital and operating expense.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A method of producing compressed natural gas from raw biogas, said method comprising the steps of:
providing a stream of raw biogas, the raw biogas including 50-70 vol % methane, 20-50 vol % carbon dioxide, and lower levels of other contaminants including nitrogen, oxygen, hydrogen sulfide, optionally siloxanes, and optionally VOCs;
feeding the raw biogas stream to an upstream-most compression stage of a multi-stage compression unit comprising two or more compression stages;
compressing the raw biogas stream in one or more compression stages of said multi-stage compression unit along with one or more recycle gas streams to produce a stream of feed gas having a pressure higher than that of the raw biogas stream;
optionally subjecting the feed gas stream to pretreatment for removal of one or more of said contaminants with pretreatment equipment;
feeding the feed gas stream, after optionally pretreating with said optional pretreatment equipment, to a gas separation membrane-based purification system comprising two or more gas separation membrane-based purification stages, each comprising one or more banks of one or more gas separation membrane modules arranged in parallel or in series, to produce a methane-enriched product gas stream, one or more waste gas streams, and one or more recycle gas streams;
compressing the methane-enriched product gas stream in one or more of the compression stages including a downstream-most compression stage of said multi-stage compression unit to produce a stream of compressed natural gas having a pressure of 30-250 bar;
withdrawing the stream of compressed natural gas as product compressed natural gas; and
feeding said one or more recycle gas streams to said upstream-most compression stage for compression together with the raw biogas stream or combining said one or more recycle gas streams with said raw biogas stream prior to their being fed to the upstream-most compression stage.

2. The method of claim 1, wherein the feed gas stream is subjected to pretreatment for removal of one or more of said contaminants with said pretreatment equipment, including one or more of a coalescer, a PSA unit, and a non-regenerable guard bed.

3. The method of claim 1, wherein the multi-stage compression unit includes, in series, first, second, and third compression stages, and:
the raw biogas stream and said one or more recycle gas streams are compressed by the first compression stage and the methane-enriched product gas stream is fed to the second compression stage, or
the raw biogas stream and said one or more recycle gas streams are compressed by the first and second compression stages and the methane-enriched product gas stream is fed to the third compression stage.

4. The method of claim 1, wherein the multi-stage compression unit includes, in series, first, second, third, and fourth compression stages, and:
the raw biogas stream and said one or more recycle gas streams are compressed by the first and second compression stages and the methane-enriched product gas stream is fed to the third compression stage, or
the raw biogas stream and said one or more recycle gas streams are compressed by the first, second, and third compression stages and the methane-enriched product gas stream is fed to the fourth compression stage.

5. The method of claim 1, wherein the multi-stage compression unit includes, in series, first, second, third, fourth, and fifth compression stages, and:
the raw biogas stream and said one or more recycle gas streams are compressed by the first and second compression stages and the methane-enriched product gas stream is fed to the third compression stage, or
the raw biogas stream and said one or more recycle gas streams are compressed by the first, second, and third compression stages and the methane-enriched product gas stream is fed to the fourth compression stage, or
the raw biogas stream and said one or more recycle gas streams are compressed by the first, second, third, and fourth compression stages and the methane-enriched product gas stream is fed to the fifth compression stage.

6. The method of claim 1, wherein the multi-stage compression unit includes, in series, first, second, third, fourth, fifth, and sixth compression stages, and
the raw biogas stream and said one or more recycle gas streams are compressed by the first and second compression stages and the methane-enriched product gas stream is fed to the third compression stage, or
the raw biogas stream and said one or more recycle gas streams are compressed by the first, second, and third compression stages and the methane-enriched product gas stream is fed to the fourth compression stage, or
the raw biogas stream and said one or more recycle gas streams are compressed by the first, second, third, and fourth compression stages and the methane-enriched product gas stream is fed to the fifth compression stage, or
the raw biogas stream and said one or more recycle gas streams are compressed by the first, second, third, fourth, and fifth compression stages and the methane-enriched product gas stream is fed to the sixth compression stage.

7. The method of claim 1, wherein said gas separation membrane-based purification system comprises first and second gas separation membrane-based purification stages and said method further comprises the steps of:
separating the feed gas with said first gas separation membrane-based purification stage into a first methane-enriched and carbon dioxide-deficient residue gas stream and a first methane-deficient and carbon dioxide-enriched permeate gas stream; and
separating all or some of the first methane-enriched and carbon dioxide-deficient residue gas stream with said second gas separation membrane-based purification stage into a second methane-enriched and carbon dioxide-deficient residue gas stream and a second methane-deficient and carbon dioxide-enriched permeate gas stream, the second methane-enriched and carbon dioxide-deficient residue gas stream being the methane-enriched product gas stream, said one or more recycle gas streams comprising the second methane-deficient and carbon dioxide-enriched permeate gas stream.

8. The method of claim 1, wherein said gas separation membrane-based purification system comprises first, second, and third gas separation membrane-based purification stages and said method further comprises the steps of:
separating the feed gas with said first gas separation membrane-based purification stage into a first methane-enriched and carbon dioxide-deficient residue gas stream and a first methane-deficient and carbon dioxide-enriched permeate gas stream;
separating all or some of the first methane-enriched and carbon dioxide-deficient residue gas stream with said second gas separation membrane-based purification stage into a second methane-enriched and carbon dioxide-deficient residue gas stream and a second methane-deficient and carbon dioxide-enriched permeate gas stream, the second methane-enriched and carbon dioxide-deficient residue gas stream being the methane-enriched product gas stream; and
separating some or all of the first methane-deficient and carbon dioxide-enriched permeate with said third gas separation membrane-based purification stage into a third methane-enriched and carbon dioxide-deficient residue gas stream and a third methane-deficient and carbon dioxide-enriched permeate gas stream, said one or more recycle gas streams being the second methane-deficient and carbon dioxide-enriched permeate gas stream and the third methane-enriched and carbon dioxide-deficient residue stream.

9. The method of claim 1, wherein said gas separation membrane-based purification system comprises first, second, third, and fourth gas separation membrane-based purification stages and said method further comprises the steps of:
separating the feed gas with said first gas separation membrane-based purification stage into a first methane-enriched and carbon dioxide-deficient residue gas stream and a first methane-deficient and carbon dioxide-enriched permeate gas stream;
separating all or some of the first methane-enriched and carbon dioxide-deficient residue gas stream with said second gas separation membrane-based purification stage into a second methane-enriched and carbon dioxide-deficient residue gas stream and a second methane-deficient and carbon dioxide-enriched permeate gas stream, the second methane-enriched and carbon dioxide-deficient residue gas stream being the methane-enriched product gas stream;
separating some or all of the first methane-deficient and carbon dioxide-enriched permeate with said third gas separation membrane-based purification stage into a third methane-enriched and carbon dioxide-deficient residue gas stream and a third methane-deficient and carbon dioxide-enriched permeate gas stream; and
separating some or all of the third methane-enriched and carbon dioxide-deficient residue with said fourth gas separation membrane-based purification stage into a fourth methane-enriched and carbon dioxide-deficient residue gas stream and a fourth methane-deficient and carbon dioxide-enriched permeate gas stream, said one or more recycle gas streams being the second methane-deficient and carbon dioxide-enriched permeate gas stream and the fourth methane-enriched and carbon dioxide-deficient residue stream.

10. The method of claim 1, further comprising obtaining said stream of raw biogas from a landfill.

11. The method of claim 1, further comprising obtaining said stream of raw biogas from a digester.

12. The method of claim 1, wherein the multi-stage compression unit comprises two to seven compression stages.
